(19) United States
(12) Patent Application Publication
(10) Pub. No.: US 2008/0046689 A1
(43) Pub. Date: Feb. 21, 2008

(54) Method and apparatus for cooperative multithreading

(76) Inventors: Tien-Fu Chen, Chia-Yi (TW); Shu-Hsuan Chou, Chia-Yi (TW); Chieh-Jen Cheng, Chia-Yi (TW); Zhi-Heng Kang, Chia-Yi (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/506,805

(22) Filed: Aug. 21, 2006

(51) Int. Cl. G06F 15/00

(52) U.S. Cl. 712/24

(57) ABSTRACT

A cooperative multithreading architecture includes an instruction cache, capable of providing a micro-VLIW instruction; a first cluster, connects to the instruction cache to fetch the micro-VLIW instruction; and a second cluster, connects to the instruction cache to fetch the micro-VLIW instruction and capable of execution acceleration. The second cluster includes a second front-end module, connects to the instruction cache and capable of requesting and dispatching the micro-VLIW instruction; a helper dynamic scheduler, connects to the second front-end module and capable of dispatching the micro-VLIW instruction; a non-shared data path, connects to the second front-end module and capable of providing a wider data path; and a shared data path, connected to the helper dynamic scheduler and capable of assisting a control part of the non-shared data path. The first cluster and the second cluster carry out execution of the respective micro-instructions in parallel.

### BACKGROUND

1. Field of Invention

The present invention relates generally to multithreaded processing. More particularly, the present invention relates to a method and apparatus for a cooperative multithreading.

2. Description of Related Art

Increasingly growth of processing power drives the inclusion of central processing units with digital signal processors for multimedia applications. As such, these processors with multiple instruction pipelines allow parallel processing of multiple instructions. However, the instruction-level parallelism is not sufficient because of data dependencies, which result in low the utilization of functional units. Therefore, thread-level parallelism is used to execute multiple threads concurrently to increase the utilization of functional units.

Superscalar processors with multithreading explored by Intel use dynamic thread creation and a detection circuitry to detect speculation errors in the execution of the threads. However, for embedded processors, a superscalar processor with multithreading has the overhead of power consumption and high design complexity, such that it is unacceptable for Digital Signal Processing (DSP) applications with power and size requirements.

VLIW processors with multithreading impose several problems with fetching VLIW instructions from multiple threads. In the VLIW architecture, fixed fetch bandwidth results in fetching only one VLIW instruction from one thread, such that thread switching timing is critical on cache miss, branch miss prediction, etc.

For the embedded processor market, low power consumption and reduced die area are critical. Moreover, several design developments must be taken into consideration. For rapid algorithm developments and architectural variations, conventional Application Specific Integrated Circuit (ASIC) designs take longer to develop and cannot meet rapid variation in both algorithms and specifications. Therefore, engineers tend to use processors or re-configurable engines to efficiently utilize programmability to develop variations. Moreover, for multimedia applications, processors must combine functionalities designed to handle different data types, for example, video and audio.

Another design development for the embedded market is high code density. Although shrink feature size makes more transistors per square millimeter, which enables larger memory systems to be integrated on a chip, high code density still dominates performance bottlenecks due to the gap between the processor and memory system.

For the foregoing reasons, there is a need to provide a method and apparatus for a cooperative multithreading.

### SUMMARY

It is therefore an aspect of the present invention to provide a processor that is able to process different embedded data types.

It is another aspect of the present invention to provide a multithreading architecture.

It is still another aspect of the present invention to provide a multithreading method.

It is still another aspect of the present invention to provide a register-based data exchange mechanism.

It is still another asepct of the present invention to provide a flexible interface for integrating the required functionality (for example, audio and video data types processing).

In accordance with the foregoing and other aspects of the present invention, one embodiment of the presentation is a cooperative multithreading architecture, comprising: an instruction cache, a first cluster and a second cluster. The first cluster is capable of carrying out routine computations. The second cluster further comprises a second front-end module, a helper dynamic scheduler, a shared data path and a non-shared data path. The first cluster and the second cluster are executed in parallel.

The second cluster is capable of execution acceleration, wherein the second-front module uses a round robin scheduling policy to access the instruction cache to fetch a micro-VLIW instructions and dispatch the micro-VLIW instruction to the helper dynamic scheduler and the non-shared data path. The helper dynamic scheduler uses a round robin scheduling policy to dispatch the micro-VLIW instruction to the shared data path.

The shared data path further comprises a plurality of helper functional units, a helper register file switch and a plurality of helper register files. The shared data path is capable of assisting the control part of the non-shared data path.

The non-shared data path includes a plurality of multiple accelerating functional units, an accelerating register file switch and a plurality of accelerating register files. The accelerating register file switch uses a partial mapping mechanism, which allocates each of the accelerating functional units with a plurality of accelerating register files. The non-shared data path is capable of providing the wider data path.

In one embodiment, a main thread is executed through a first cluster, the first cluster detects a start thread instruction from the main thread and passes a plurality of parameters (including a program counter value) from the main thread to create a helper thread. The main thread and the helper thread are executed in parallel. The helper thread is executed through a second cluster further comprises a second front-end module that uses a round robin scheduling policy to fetch a micro-VLIW instruction from an instruction cache. The second front-end module dispatches the micro-VLIW instruction to a helper dynamic scheduler and a non-shared data path. The helper dynamic scheduler selects the micro-VLIW instruction using a round robin scheduling policy and dispatches the micro-VLIW instruction to a helper functional unit. The helper functional unit sends a plurality of read/write requests to a helper register file switch and then the helper register file uses the helper thread ID and sends the read/write requests to a helper register file. An accelerating register unit receives the micro-VLIW instruction from the second front-end module and sends a plurality of read/write requests to an accelerating register file switch. In one embodiment, the accelerating register unit uses the partial mapping mechanism to sends the read/write requests to two of the accelerating register files.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram of one embodiment of a cooperative multithreading architecture.

FIG. 2 is the flowchart of creating a helper thread.

FIG. 3 shows an example of the helper thread creation function.

FIG. 4 shows an example of the check thread function.

FIG. 5 is a schematic diagram of one embodiment of the second front-end module.

FIG. 6 is a schematic diagram of one embodiment of the dispatcher of the second front-end module.

FIG. 7A-7D are schematic diagrams of one embodiment of the partial mapping mechanism.

FIG. 8 is a schematic diagram of one embodiment of the software module.

FIG. 9 is a flowchart of one embodiment of the main thread program flow.

FIG. 10 is a flowchart of one embodiment of the helper thread program flow.

FIG. 11 illustrates the embodiment of the overall program flow.

### DESCRIPTION OF THE PREFERRED EMBODIMENTS

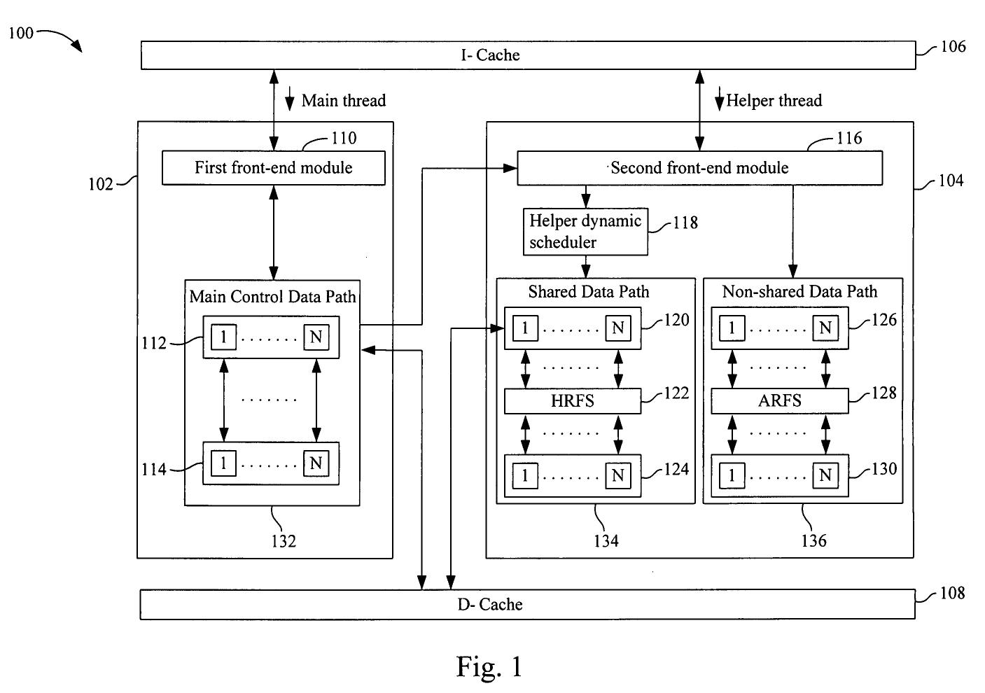

FIG. 1 is a schematic diagram of a cooperative multithreading architecture 100 with which the present invention may be implemented. The cooperative multithreading architecture 100 includes a first cluster 102 and a second cluster 104, wherein a main thread goes through the first cluster 102 and a helper thread goes through the second cluster 104.

The first cluster 102 is capable of controlling and carrying out routine computations. The first cluster 102 includes a first front-end module 110 and a main control data path 132, wherein the main control data path 132 includes a plurality of functional units 112 and a plurality of register files 114. The first front-end module 110 may use Reduced Instruction Set Computing (RISC) operations for branch, load, store, arithmetic and logical operations, etc. The operations for functional units 112 are multiply-and-add or Single Instruction Multiple Data (SIMD), etc. Moreover, the first cluster 102 takes charge of creating a helper thread.

The second cluster 104 is capable of execution acceleration. The second cluster 104 includes a second front-end module 116, a Helper Dynamic Scheduler (HDYS) 118, a shared data path 134 and a non-shared data path 136.

The shared data path 134 includes a plurality of helper functional units 120, a Helper Register File Switch (HRFS) 122 and a plurality of helper register files 124. The second front-end module 116 is connected to the instruction cache (I-Cache) 106. The helper dynamic scheduler 118 is connected to the second front-end module 116. The helper functional units 120 are connected to the helper dynamic scheduler 118. The helper register file switch 122 is connected to the helper functional units 120 and the helper register files 124 are connected to the helper register file switch 122.

The non-shared data path 136 includes a plurality of accelerating functional units 126, an Accelerating Register File Switch (ARFS) 128 and a plurality of accelerating register files 130. The accelerating functional units 126 are connected to the second front-end module 116. The Accelerating Register File Switch (ARFS) 128 is connected to the accelerating functional units 126. The accelerating register files 130 are connected to the Accelerating Register File Switch 128. The accelerating functional units 126 are capable of certain accelerations for embedded applications. Further, each of the helper functional units 120 is shared by the helper threads. The helper functional units 120 assist a control part of the helper threads. For example, each of the helper functional units 120 of the shared data path 134 loads data from a Data Cache (D-cache) 108 to the accelerating register files 130 of the non-shared data path 136.

The helper register files 124 are accessed by the helper functional units 120 via the HRFS 122. Each of the helper threads is allocated one of the helper register files 126 to provide helper thread program flow control. In one embodiment, for multimedia operations, each of the helper threads are allocated two of the accelerating register files 130 to provide a wider data path, wherein one of the accelerating register files 130 is used for loaded data and the other one of the accelerating register files 130 is used for data execution.

Referring to FIG. 1, the main thread is capable of creating the helper threads. While creating the helper thread, the main thread specifies one of the helper register files 124 and two of the accelerating register files 130 will be used by the created helper thread. The accelerating register file switch 128 provides the helper threads to access the accelerating register files 130.

Referring to FIG. 1, one embodiment may be implemented using a 2-port instruction cache (I-Cache) 106 where the bandwidth of the ports is 128-bit. The D-cache 108 is a 2-port data cache, one is 32-bits and the other is 64-bits to support a wider data flow.

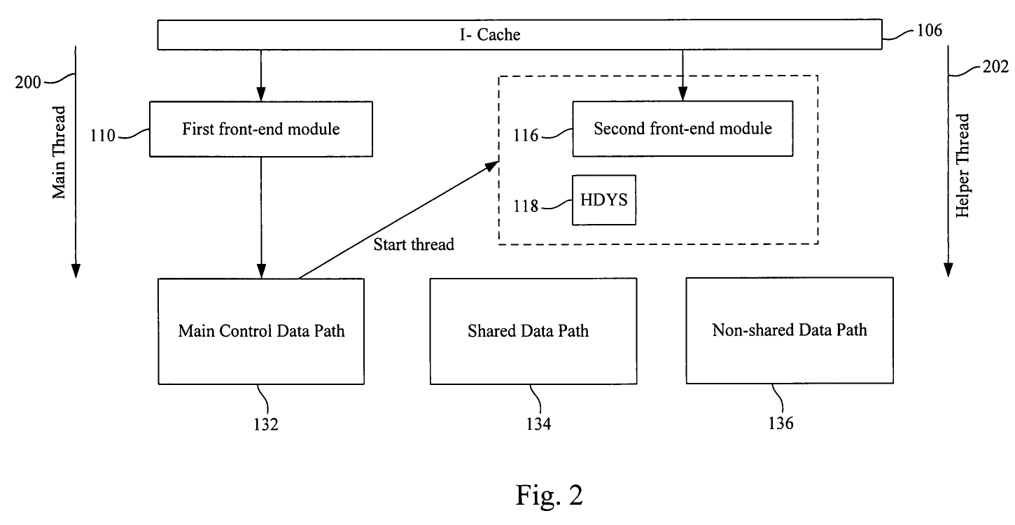

The flowchart of how one embodiment creates a helper thread is illustrated in FIG. 2. One embodiment of the present invention may be implemented by using a programming language to create the helper thread, thus lowering both the logic required to create a helper thread and the additional detection logic used for speculation detection and recovery. As shown in FIG. 2, when a main thread 200 detects a start thread instruction, a helper thread 202 will be created based on the program counter value and parameters of the main thread 200 with a start thread instruction. Hence, each helper thread 202 has a program counter value such that each helper thread 202 can fetch respective firmware code from the memory systems. At the same time, the main thread 200 continues executing through the first cluster 102 in parallel with the helper thread 202 executing through the second cluster 104. Synchronization between the main thread 200 and the helper thread 202 is called by main thread 200 to check whether the helper thread 202 has finished the execution of the data stream.

For the foregoing objectives to provide a user friendly development environment, for example, two functions are established in the C programming language. The first function, the helper thread creation function, detects a start thread instruction. The second function, the check thread functions, detects whether or not the helper thread has finished the execution. The helper thread creation function and the check thread function are written using inline assembly language to minimize the processing overhead when the main thread creates the helper thread or the main thread checks the status of the helper thread. The helper thread creation function and the check thread function here use C and assembly language to achieve the foregoing objectives; however, this does not limit the scope of the present invention as these two functions can be written in any programming language to perform the foregoing objectives.

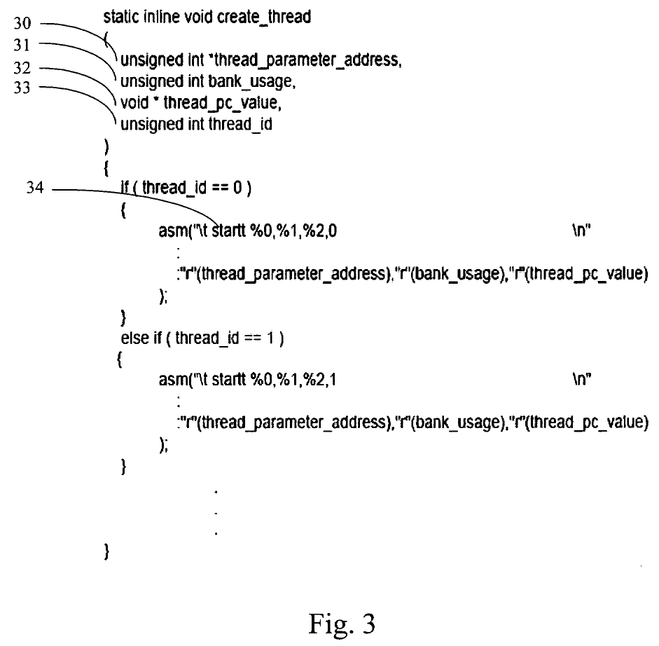

The helper thread creation function is illustrated in FIG. 3. Users only need to enter four parameters into the function. The “thread_id” parameter 33 indicates which helper thread should be created. The “thread_pc_value” parameter 32 is the start address of the helper thread firmware code. The “bank_usage” parameter 31 decides how to map posts to the helper register files and the accelerating register files. The “thread_parameter_address” parameter 30 passes the start address of a parameter address list from the main thread to the helper thread. This function uses an “if” statement to determine the identification of the created thread. A helper thread is then created by the inline assembly language—the “startt” instruction 34. The grammar of the inline assembly follows the OGCC assembly document.

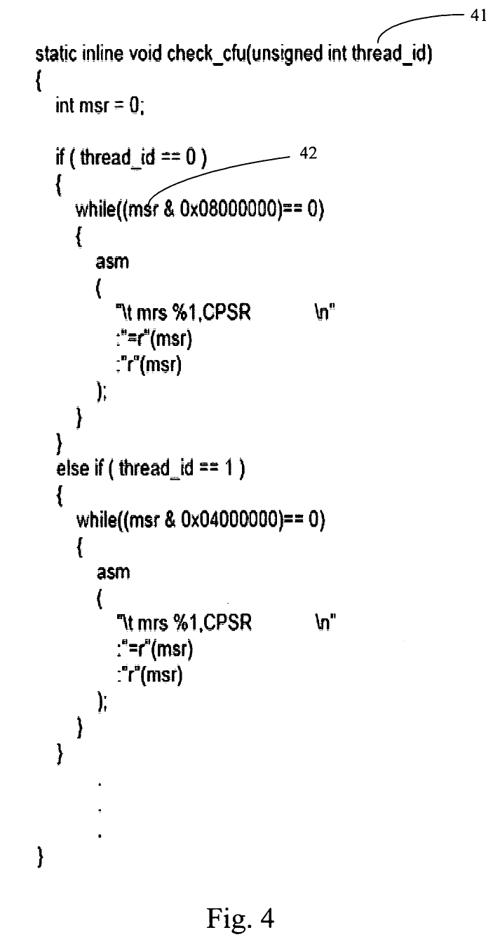

FIG. 4 shows the check thread function written in the C language and containing some inline assembly language. The parameter of the check thread function is the thread identification (thread_id) 41. An “if” statement checks the wanted thread identification. The main thread uses the “msr” instruction 42 to copy the information written by a helper thread to one of the register files 114 located in the first cluster 102. The register file 114 then gets the status of the helper thread by masking the information.

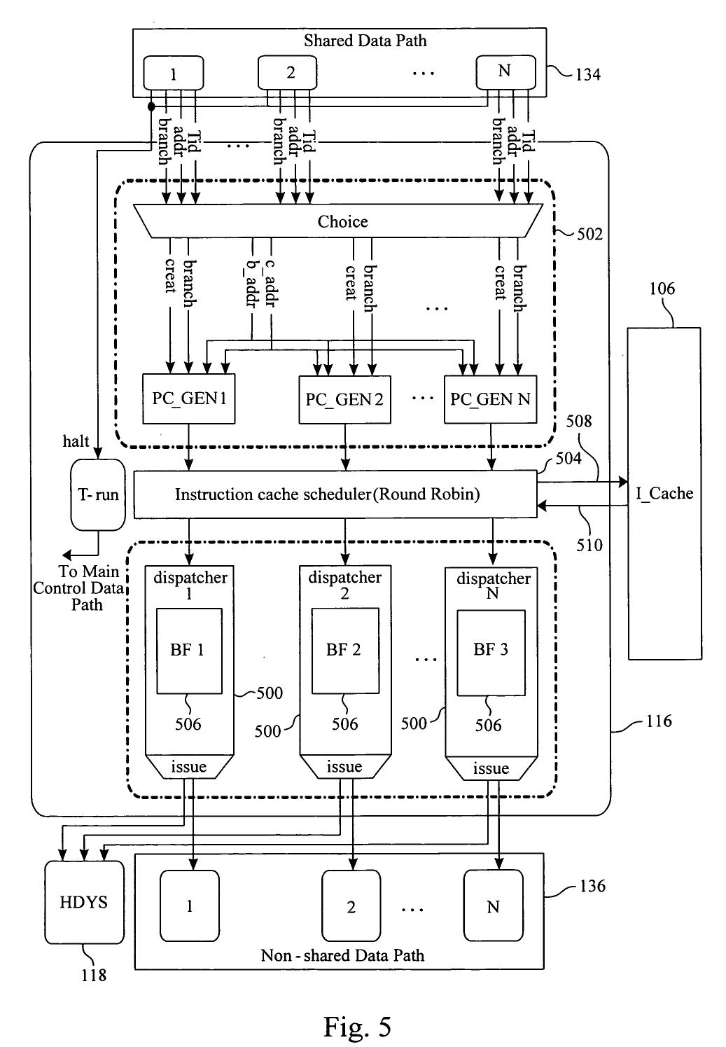

FIG. 5 illustrates one embodiment of the second front-end module 116 with the instruction cache 106. The second front-end module 116 includes a program counter address generator 502, an Instruction Cache Scheduler (ICS) 504 and a plurality of dispatchers 500. The second front-end module 116 fetches a micro-VLIW instruction from the I-cache 106, and the fetched micro-VLIW instruction is then respectively dispatched to the Helper Dynamic Scheduler (HDYS) 118 and non-shared data path 136 by the dispatcher 500.

The program counter address generator 502 is used to generate an address in order to use the address to request the micro-VLIW instruction from the instruction cache 106.

Referring to FIG. 5, the ICS 504 requests instruction 508 from the instruction cache 106 and receives a micro-VLIW instruction data 510. Due to the port constraint, only one helper thread can access the instruction cache 106. Therefore, the ICS 504 uses a thread switching mechanism to select the helper thread according to the status of the helper threads.

The thread switching mechanism uses a proposal from one embodiment of the present invention called a round robin scheduling policy which treats each helper thread with the same priority. For example, the steps for performing the round robin scheduling policy to select one helper thread from four helper threads in order to access the I-cache 106 are listed below.

1. Provided four helper threads HT1, HT2, HT3 and HT4 request access to the I-cache 106 by the ICS 504.

2. Provided the last time the helper thread ID “N” accesses the I-cache 106 by the ICS 504.

3. The priority for the helper threads HT1, HT2, HT3 and HT4 to access the I-cache 106 are (N+1)% 4, (N+2)% 4, (N+3)% 4 and (N)% 4 respectively.

The above helper thread switching mechanism simplifies design complexity and avoids helper thread starvation because each helper thread accesses the I-cache 106 in successive order.

Referring to FIG. 5, the dispatcher 500 receives the micro-VLIW instruction of the requested helper thread from the instruction cache scheduler 504 and stores the fetched micro-VLIW instruction in an instruction buffer (one of BF 1 to BF N) 506. Furthermore, the dispatcher 500 takes each micro-VLIW instruction (which is the read/write requests) out of the instruction buffers 506 and dispatches micro-VLIW instructions to the helper dynamic scheduler (HDYS) 118 and the non-shared data path 136, respectively.

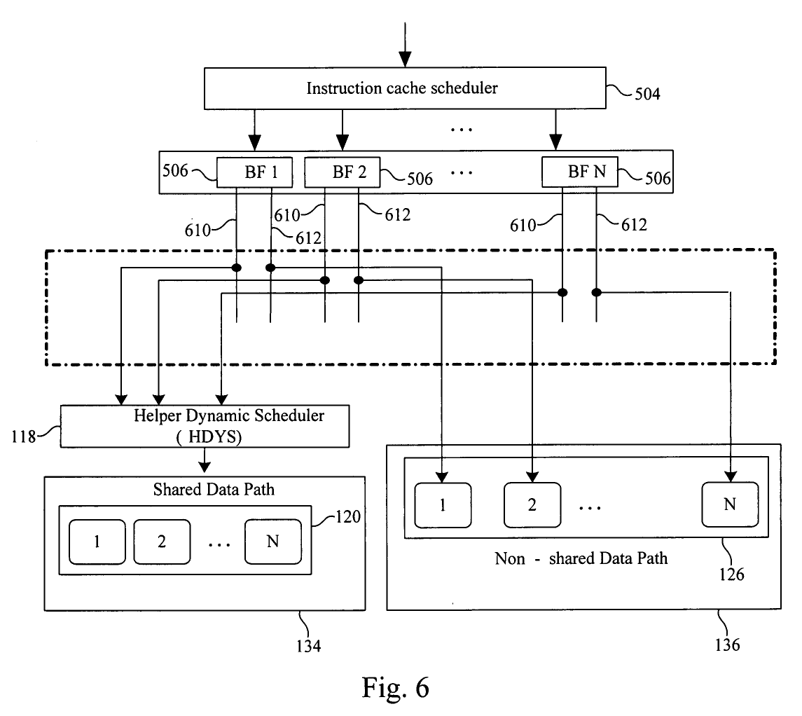

FIG. 6 illustrates one embodiment of the micro-operations dispatch from the instruction buffer (BF 1 to BF N) 506. At each cycle, each of the micro-VLIW instructions 610 and 612 in the BF (BF 1 to BF N) is passed to the HDYS 118 and accelerating functional units 136 respectively, such that at each cycle, the HDYS 118 and the accelerating functional units 136 receive N micro-VLIW instructions 610, 612 from N helper threads respectively if there are N helper threads started by the main thread.

A necessary design development is to determine how many helper functional units 120 are required to cooperate with accelerating functional units 126. Since every accelerating functional unit 126 takes charge of execution acceleration, therefore, data must be prepared in advance for execution. Moreover, there are still space and power considerations. For this reason, the helper functional units 120 do not necessarily have to be provided with as many accelerating functional units 126. However, since each cycle has at most N micro-VLIW instructions 610 dispatched to the helper functional units 120, a helper dynamic scheduler 118 must be integrated to schedule which micro-VLIW 610 should be executed by which helper functional unit 120.

Referring to FIG. 1 and FIG. 6, the Helper Dynamic Scheduler (HDYS) 118 is connected between the second front-end module 116 and the helper functional units 120. The HDYS 118 adopts a round robin scheduling policy and uses the helper thread ID to identify a micro-operation and passes the micro-VLIW instructions 610 to one of the helper functional units 120. Note that the rule to pass the micro-VLIW instructions 610 to one of the helper functional units 120 is broken when the functional units 120 is executing the repeat instruction. Therefore the current micro-VLIW instructions 610 is tried at each cycle attempting to access till the helper functional units 120 finished the repeated instruction.

The round robin scheduling policy is performed to find the priority order of the helper threads (For example, M helper thread), and the helper thread with the highest priority can pass the micro-instruction (which is the micro-VLIW) to one of the helper functional units 120, wherein the amount M is the number of the helper functional units 120 (which means the amount of the helper functional units is equal to the amount of the helper threads). When the helper thread with the highest priority is selected by the HDYS 118, the next time the priority of this helper thread is changed to the lowest one. Consequently, helper thread starvation is avoided.

The helper functional units 120 are capable of assisting the control part of the helper threads and each helper thread uses its allocated helper register file 124. Each helper functional unit 120 executes simple RISC operations, such as load/store, branch, and arithmetic operations. When a helper thread needs to access the helper register file 124, the ID of the helper thread is followed going through the helper function unit 120. Then the helper register file switch 122 illustrated in FIG. 1 will use the helper thread ID to access the required helper register file 124.

The accelerating functional units 126 (AFUs) are used to execute accelerations. One embodiment of the present invention may be implemented in the following arrangement for the second cluster 104. For example, if a multimedia application is executed, then different types of multimedia accelerating function units 126 can be integrated to achieve real-time constraints. With the help of accelerating functional units 126, the conventional way that an operation needs hundreds of cycles to be completed by a RISC functional unit now only needs one accelerating instruction to finish execution, which can efficiently speed up the computations. For example, for the MPEG4 codec, four AFUs 126 are used, and the four AFUs 126 are two vector functional units, a butterfly, and a VLC/VLD (Variable Length Coding/Variable Length Decoding) functional unit. The Vector functional unit is responsible for SIMD processing operations that process a number of blocks of data in parallel. The SIMD operations can accelerate the image computations. The butterfly functional unit is in charge of processing SIMD data type. However, the main functionalities of the butterfly functional unit are multiply-and-add (MAC) operations and matrices multiply operations. The butterfly functional unit can also be used to accelerate DCT/IDCT operations.

The VLC/VLD functional unit is used to accelerate MPEG4 VLC and VLD operations.

Referring to FIG. 1, the shared data path 134 has N helper register files 124, and the non-shared data path 136 has 2N accelerating register files 130, wherein N is the number of accelerating functional units 126. However, if each helper thread uses any two of the accelerating register files 130, this will significantly increase the complexity of the logic of the accelerating register file switch 128. In one embodiment, in order to reduce the complexity of the logic of the accelerating register file switch 128, a partial mapping mechanism is taken into consideration. The partial mapping mechanism allocates each of the accelerating functional units 126 with a plurality of accelerating register files 130.

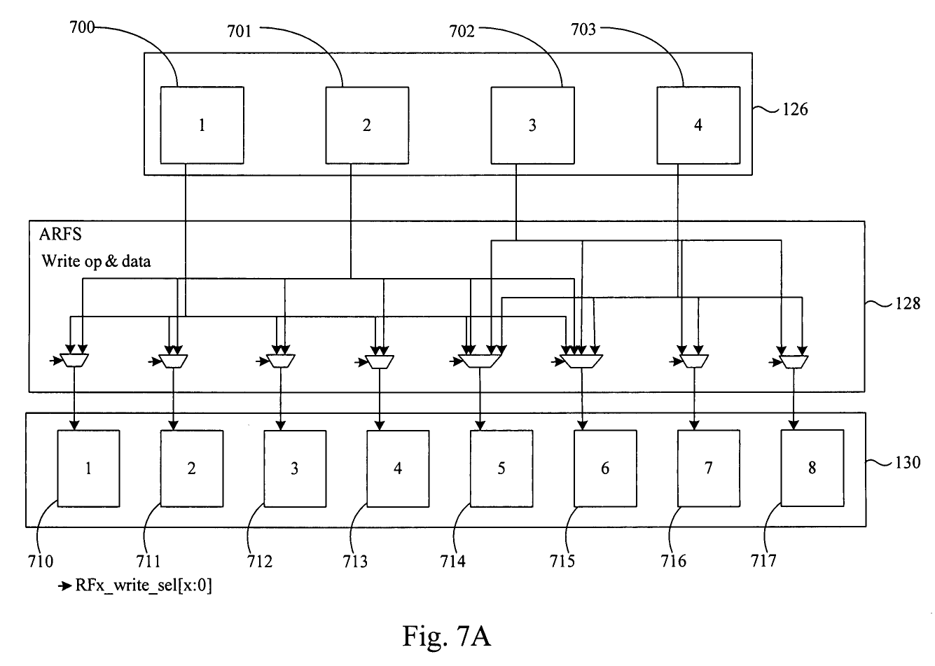

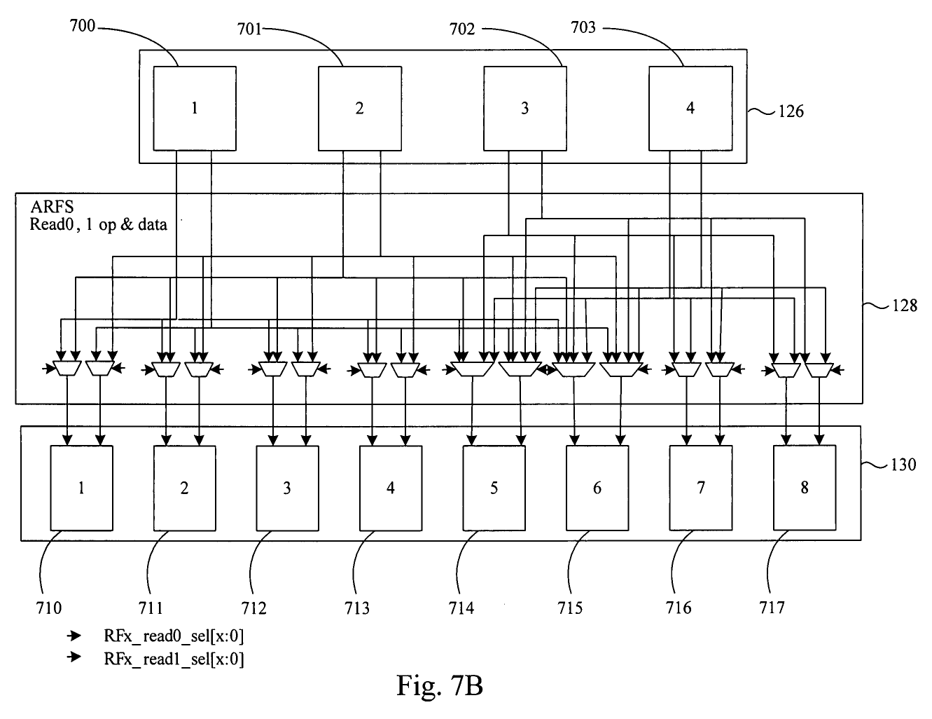

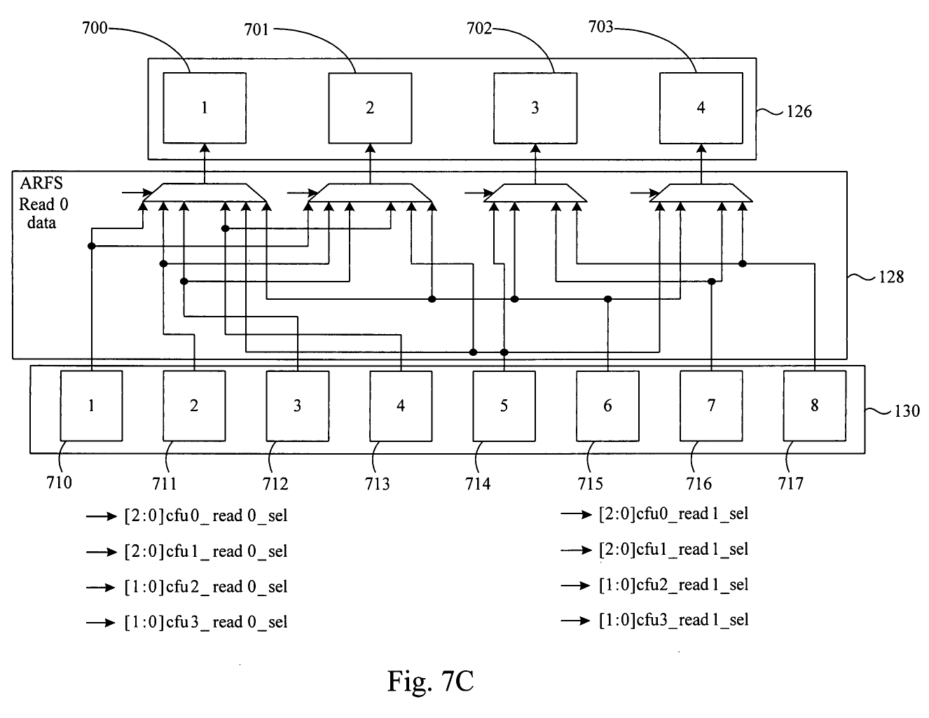

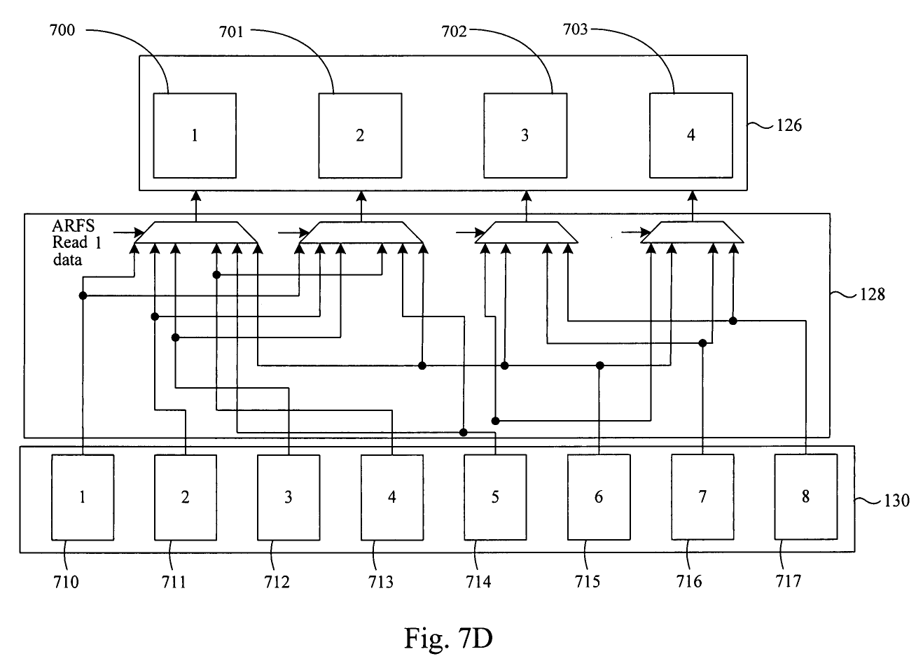

FIG. 7A-7D illustrate one embodiment of the partial mapping mechanism. For example, the accelerating functional unit 1 700 and the accelerating functional unit 2 701 can use the accelerating register file 1 to the accelerating register file 6 (710, 711, 712, 713, 714 and 715), and the accelerating functional unit 3 702 and the accelerating functional unit 4 703 can use the accelerating register file 5 to the accelerating register file 8 (714, 715, 716 and 717). The selection of the accelerating register file 130 relies on several multiplexers. FIG. 7B depicts read requests to the accelerating register files 130, and data is returned back as shown in FIG. 7C and 7D. Write operations are depicted in FIG. 7A.

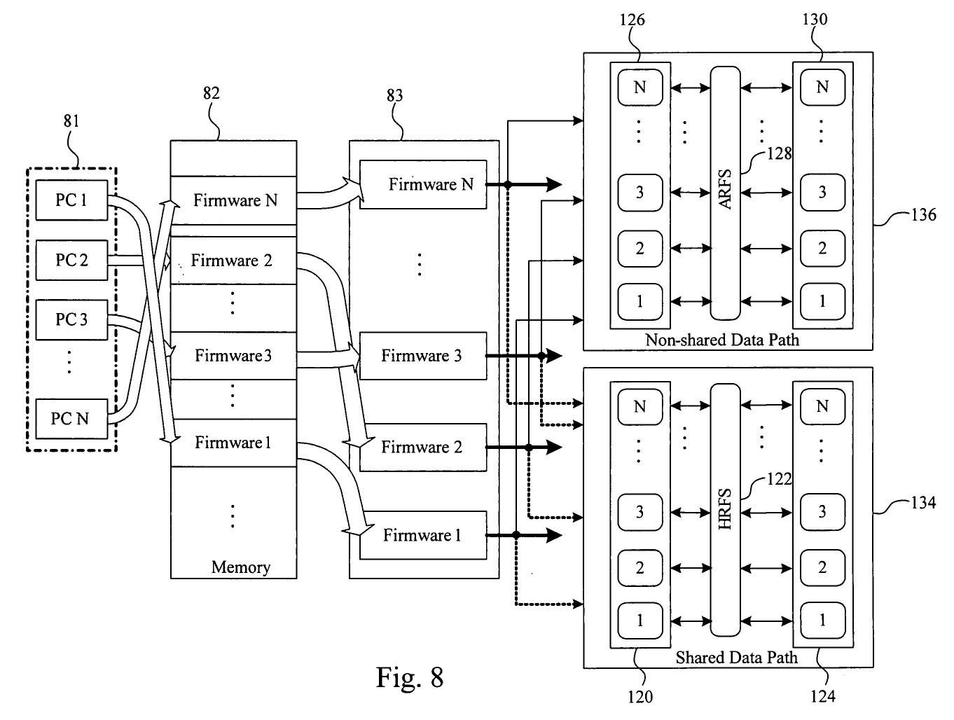

FIG. 8 illustrates one embodiment of accessing the firmware code. Each program counter (PC) 81 points to a memory segment 82 such that a firmware code 83 is located in the segment 82. The firmware code 83 is then fetched by the second front-end module 116 of cluster 2 104 (FIG. 1) and dispatched to the accelerating functional units 126 and through Helper Dynamic Scheduler (FIG. 1) to the helper functional units 120 for execution.

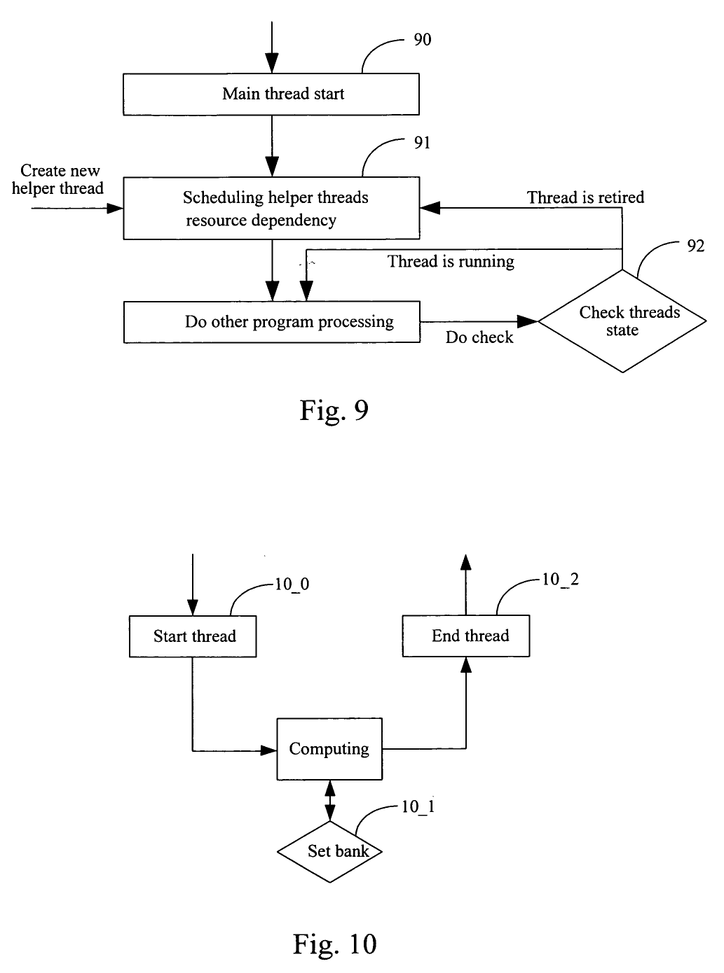

FIG. 9 illustrates one embodiment of the main thread program flowchart. As shown in FIG. 9, after the main thread starts 90, it will create a helper thread for acceleration. The most important is how to schedule the orders of helper threads and resource dependencies 91. While a helper thread is halted, the helper thread will write some information to its own helper register file and this information is used to check whether a helper thread is halted 92.

FIG. 10 illustrates one embodiment of helper thread program flow. While a helper thread is created 10_0, the helper thread will fetch its own firmware code from the instruction cache. If the firmware code wants to read or write the other accelerating register file, then a set-bank instruction is used to change the accelerating register file port pointer 10_1. After firmware code finishes its execution, the helper thread is halted 10_2 and some information will be written to the helper register file by the helper functional unit.

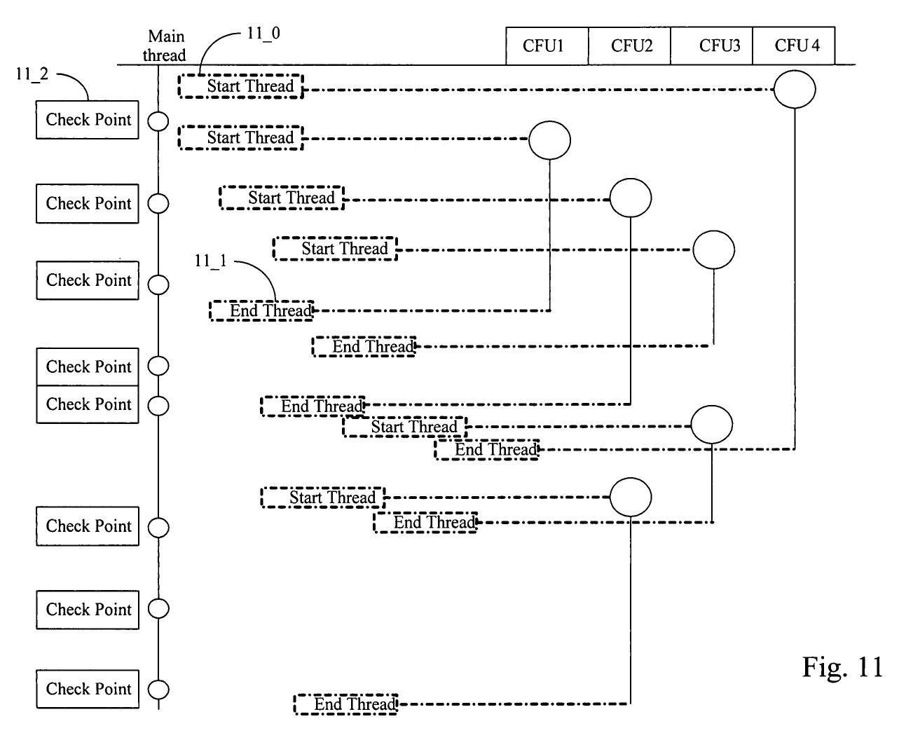

FIG. 11 illustrates one embodiment of the overall program flow. The figure illustrates the time to start a helper thread 11_0, the time that a helper thread is halted 11_1, and the time that the main thread checks to see if a helper thread is halted 11_2. The check point is the time that the main thread checks whether a helper thread is halted 11_2.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A cooperative multithreading architecture, comprising:
an instruction cache, capable of providing a micro-VLIW instruction;
a first cluster, connects to the instruction cache to fetch the micro-VLIW instruction and capable of carrying out routine computation; and
a second cluster, connects to the instruction cache to fetch the micro-VLIW instruction and capable of execution acceleration, wherein the second cluster further comprises:
a second front-end module, connects to the instruction cache and capable of requesting and dispatching the micro-VLIW instruction;
a helper dynamic scheduler, connects to the second front-end module and capable of dispatching the micro-VLIW instruction;
a non-shared data path, connects to the second front-end module and capable of providing a wider data path; and
a shared data path, connected to the helper dynamic scheduler and capable of assisting a control part of the non-shared data path;
wherein the second front-end module dispatches the micro-VLIW instruction to the helper dynamic scheduler and the non-shared data path, and the first cluster and the second cluster carry out execution of the respective micro-instructions in parallel.

2. The cooperative multithreading architecture as claimed in claim 1, wherein the second front-end module further comprises an instruction cache scheduler to request and dispatch the micro-VLIW instruction.

3. The cooperative multithreading architecture as claimed in claim 2, wherein the instruction cache scheduler uses a round robin scheduling policy to request the micro-VLIW instruction from the instruction cache.

4. The cooperative multithreading architecture as claimed in claim 1, wherein the helper dynamic scheduler uses a round robin scheduling policy.

5. The cooperative multithreading architecture as claimed in claim 1, wherein the shared data path further comprises:
a plurality of helper functional units, connected to the helper dynamic scheduler to receive the micro-VLIW instruction;
a helper register file switch, connected to the helper functional units and capable of sending a plurality of read/write requests; and
a plurality of helper register files, connected to the helper register file switch and capable of providing a control information.

6. The cooperative multithreading architecture as claimed in claim 5, wherein the non-shared data path further comprises:
a plurality of accelerating functional units, connected to the second front-end module to receive the micro-VLIW instruction;
an accelerating register file switch, connected to the accelerating functional units and capable of sending a plurality of read/write requests; and
a plurality of accelerating register files, connected to the accelerating register file switch and capable of speedup the computations.

7. The cooperative multithreading architecture as claimed in claim 6, wherein the accelerating register file switch uses a partial mapping mechanism.

8. A method of multithreading, comprising the steps of:
executing a main thread in a first cluster;
creating a plurality of helper threads; and
executing each of the helper threads in a second cluster, further comprising:
fetching a micro-VLIW instruction from an instruction cache through a second front-end module;
dispatching the micro-VLIW instruction to a helper dynamic scheduler and a non-shared data path through the second front-end module;
selecting the micro-VLIW instruction and dispatches to a shared data path from the helper dynamic scheduler;
executing the micro-VLIW instruction in the shared data path; and
executing the micro-VLIW instruction in the non-shared data path;
wherein the main thread and the helper thread are executed in parallel.

9. The method as claimed in claim 8, wherein the creation of each of the helper threads further comprises:
detecting a start thread instruction from the main thread; and
passing a plurality of parameters from the main thread to the helper thread.

10. The method as claimed in claim 9, wherein the parameters include a program counter value.

11. The method as claimed in claim 8, wherein the second front-end module uses a round robin scheduling policy to access the instruction cache.

12. The method as claimed in claim 8, wherein the helper dynamic scheduler uses a round robin scheduling policy to select the micro-VLIW instruction.

13. The method as claimed in claim 8, wherein the step of executing the micro-VLIW instruction in the shared data path further comprises:
receiving the micro-VLIW instruction from the helper dynamic scheduler to one of the helper functional units;
sending a plurality of read/write requests to a helper register file switch from the helper functional unit; and
sending the read/write requests to one of the helper register files from the helper register file switch.

14. The method as claimed in claim 8, wherein the step of executing the micro-VLIW instruction in the non-shared data path further comprises:
receiving the micro-VLIW instruction from the second front-end module to one of the accelerating functional units;
sending a plurality of read/write requests to an accelerating register file switch from the accelerating functional unit; and
sending the read/write requests to two of the accelerating register files from the accelerating register file switch.

15. The method as claimed in claim 14, wherein the accelerating register file switch uses a partial mapping mechanism to send the read/write requests to the accelerating register file switches.

16. A cooperative multithreading architecture, comprising:
an instruction cache, capable of providing a micro-VLIW instruction;
a first cluster, connected to the instruction cache to fetch the micro-VLIW instruction and capable of carrying out routine computation; and
a second cluster, connected to the instruction cache to fetch the micro-VLIW instruction and capable of execution acceleration, wherein the second cluster further comprises:
a second front-end module, connected to the instruction cache and capable of requesting and dispatching the micro-VLIW instruction;
a helper dynamic scheduler, connected to the second front-end module and capable of dispatching the micro-VLIW instruction;
a plurality of helper functional units, connected to the helper dynamic scheduler to receive the micro-VLIW instruction;
a helper register file switch, connected to the helper functional units and capable of sending a plurality of read/write requests;
a plurality of helper register files, connected to the helper register file switch, capable of providing the control information;
a plurality of accelerating functional units, connected to the second front-end module to receive the micro-VLIW instruction;
an accelerating register file switch, connected to the accelerating functional units and capable of sending a plurality of read/write requests; and
a plurality of accelerating register files, connected to the accelerating register file switch and capable of speedup the computations;
wherein the second front-end module dispatches the micro-VLIW instruction to the helper dynamic scheduler and the non-shared data path, and the first cluster and the second cluster carry out execution of the respective micro-instructions in parallel.

17. The cooperative multithreading architecture as claimed in claim 16, wherein the second front-end module further comprises an instruction cache scheduler for requesting and dispatching the micro-VLIW instruction.

18. The cooperative multithreading architecture as claimed in claim 17, wherein the instruction cache scheduler uses a round robin scheduling policy to request the micro-VLIW instruction from instruction cache.

19. The cooperative multithreading architecture as claimed in claim 16, wherein the helper dynamic scheduler uses a round robin scheduling policy.

20. The cooperative multithreading architecture as claimed in claim 16, wherein the accelerating register file switch uses a partial mapping mechanism.
